(19) United States
(12) Patent Application Publication
(10) Pub. No.: US 2011/0267459 A1
(43) Pub. Date: Nov. 3, 2011

(54) PORTABLE APPARATUS FOR PROCESSING MEASUREMENT DATA AND METHOD THEREOF

(75) Inventor: Young Sang CHOI, Seongnam-si (KR)

(73) Assignee: SAMSUNG ELECTRONICS CO., LTD., Suwon-si (KR)

(21) Appl. No.: 12/968,755

(22) Filed: Dec. 15, 2010

(30) Foreign Application Priority Data
May 3, 2010 (KR) 10-2010-0041356

(51) Int. Cl. H04N 7/18

(52) U.S. Cl. 348/135; 348/E07.088

(57) ABSTRACT

A portable apparatus for processing measurement data and a method thereof are provided. The portable apparatus may extract measurement data from a captured image representing a measurement device, and may store and manage the extracted measurement data together with a type of the measurement data.

### CROSS-REFERENCE TO RELATED APPLICATION(S)

This application claims the benefit under 35 U.S.C. §119(a) of Korean Patent Application No. 10-2010-0041356, filed on May 3, 2010, in the Korean Intellectual Property Office, the entire disclosure of which is incorporated herein by reference.

### BACKGROUND

1. Field

The following description relates to a portable apparatus for processing measurement data and a method thereof, and more particularly, to a portable apparatus for processing measurement data and a method thereof that may extract measurement data measured by a measurement device, and may process the extracted measurement data.

2. Description of Related Art

Data regarding body weight, blood pressure, or other measurements may be managed by a portable apparatus using the following scheme. Generally, a measurement device for measuring and generating data regarding body weight or blood pressure includes a module having a communication function. The measurement device may transmit measurement data to the portable apparatus via the module, or via a wired or wireless interface cable. Alternatively, the portable apparatus may include a module for measuring and generating data.

However, the above scheme may increase costs of the measurement device or the portable apparatus, may cause a problem in standardization for data transmission between the measurement device and the portable apparatus, and may require complex operations such as cable connection and manipulation.

### SUMMARY

In one general aspect, there is provided a portable apparatus, including: an image capturing unit configured to acquire a captured image by capturing a measurement device on which measurement data is displayed, a controller configured to extract the measurement data from the acquired captured image, and a storage unit configured to store at least one of: the extracted measurement data and the acquired captured image.

In the portable apparatus, the controller may be further configured to: extract the measurement data from the acquired captured image, and control the storage unit to store the extracted measurement data, in response to an image corresponding to the measurement device existing among a plurality of images that represent a plurality of measurement devices and that are stored in advance.

The portable apparatus may further include a User Interface (UI) unit configured to receive a type of the measurement data, the type being input by a user.

In the portable apparatus, the controller is further configured to control the storage unit to store the measurement data and the type of the measurement data received by the UI unit, in response to an image corresponding to the measurement device not existing among a plurality of images that represent a plurality of measurement devices and that are stored in advance.

The portable apparatus may further include a communication unit configured to transmit the extracted measurement data to a management server.

In the portable apparatus, the controller may be further configured to control the storage unit to further store at least one of: a type of the measurement data, a time at which the measurement data is measured, a location where the measurement data is measured, and information regarding a user corresponding to the measurement data.

In the portable apparatus, the type of the measurement data may be determined based on an image corresponding to the measurement device among a plurality of images that represent a plurality of measurement devices and that are stored in advance.

In the portable apparatus, in response to the acquired captured image including a unit symbol for the measurement data, the controller may be further configured to: extract the unit symbol along with the measurement data, and control the storage unit to store the extracted unit symbol and the extracted measurement data.

In another general aspect, there is provided a method of processing measurement data in a portable apparatus, the method including: acquiring a captured image by capturing a measurement device on which measurement data is displayed, extracting the measurement data from the acquired captured image, and storing at least one of the extracted measurement data and the acquired captured image.

In the method, the extracting may include extracting the measurement data from the acquired captured image, in response to an image corresponding to the measurement device existing among a plurality of images that represent a plurality of measurement devices and that are stored in advance.

The method may further include: receiving a type of the measurement data, in response to an image corresponding to the measurement device not existing among a plurality of images that represent a plurality of measurement devices and that are stored in advance, the type being input by a user, and storing the received type of the measurement data.

The method may further include transmitting the extracted measurement data to a management server.

In the method, the storing may include further storing at least one of: a type of the measurement data, a time at which the measurement data is measured, a location where the measurement data is measured, and information regarding a user corresponding to the measurement data.

In the method, the type of the measurement data may be determined based on an image corresponding to the measurement device among a plurality of images that represent a plurality of measurement devices and are stored in advance.

A non-transitory computer readable recording medium may store a program to cause a computer to implement the method.

In another general aspect, there is provided a portable apparatus, including: an image capturing unit configured to acquire a captured image by capturing a measurement device on which measurement data is displayed, a controller configured to extract the measurement data from the acquired captured image, and a communication unit configured to transmit, to a management server, at least one of: the extracted measurement data and the acquired captured image.

In the portable apparatus, the controller may be further configured to: extract the measurement data from the acquired captured image, and control the storage unit to store the extracted measurement data, in response to an image corresponding to the measurement device existing among a plurality of images that represent a plurality of measurement devices and that are stored in advance.

The portable apparatus may further include a User Interface (UI) unit configured to receive a type of the measurement data, the type being input by a user.

In the portable apparatus, the controller may be further configured to control the storage unit to store the measurement data and the type of the measurement data received by the UI unit, in response to an image corresponding to the measurement device not existing among a plurality of images that represent a plurality of measurement devices and that are stored in advance.

In the portable apparatus, the controller may be further configured to control the storage unit to further store at least one of: a type of the measurement data, a time at which the measurement data is measured, a location where the measurement data is measured, and information regarding a user corresponding to the measurement data.

Other features and aspects may be apparent from the following detailed description, the drawings, and the claims.

### BRIEF DESCRIPTION OF THE DRAWINGS

FIG. 1 is a block diagram illustrating an example of a portable apparatus for processing measurement data according to an embodiment.

FIG. 2 is a block diagram illustrating an example of a controller of the portable apparatus of FIG. 1.

FIG. 3 is a block diagram illustrating an example of a system for processing measurement data according to an embodiment.

FIG. 4 is a flowchart illustrating an example of a method of processing measurement data by a portable apparatus according to an embodiment.

FIG. 5 is a flowchart illustrating an example of a method of processing measurement data by a portable apparatus and a management server according to an embodiment.

FIG. 6 is a flowchart illustrating another example of a method of processing measurement data by a portable apparatus and a management server according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

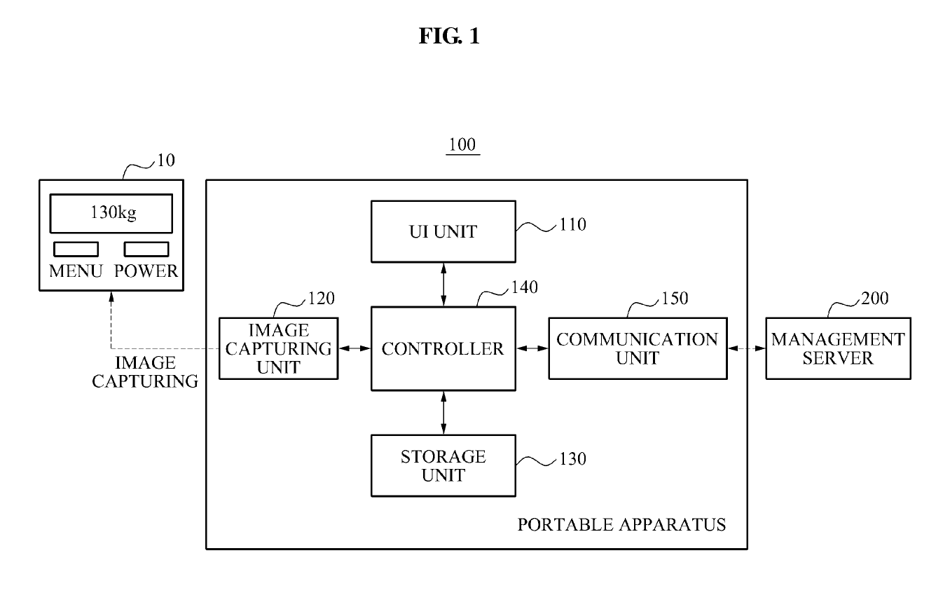

FIG. 1 is a block diagram illustrating an example of a portable apparatus 100 for processing measurement data according to an embodiment.

The portable apparatus 100 of FIG. 1 may have a camera function, may recognize characters contained in a captured image, and may store and manage the characters. In FIG. 1, the portable apparatus 100 may include a User Interface (UI) unit 110, an image capturing unit 120, a storage unit 130, a controller 140, and a communication unit 150.

The UI unit 110 may provide interfacing between a user and the portable apparatus 100. Additionally, the UI unit 110 may receive input by the user via manipulation for a predetermined command. The UI unit 110 may be variously implemented, for example, as a button, a key, a wheel, or a touch screen. These are nonlimiting examples. The UI unit 110 may display various UIs to be provided to the user. For example, the UI unit 110 may display a UI to receive an input of a type of a measurement device 10 captured (e.g., photographed) by the image capturing unit 120. In one example, the user may input the type of the measurement device 10 captured by the image capturing unit 120, or a type of data measured by the measurement device 10, through the UI displayed on the UI unit 110. The type of the measurement device 10 may also be automatically transmitted.

The image capturing unit 120 may be used as a camera module, and may acquire a captured image by capturing the measurement device 10 on which measurement data is displayed. The measurement device 10 may function to generate data from a measurement, and may be implemented as a device enabling numerical values or records to be generated via a measurement, for example, a body weight scale for measuring body weight, a device for measuring blood pressure, a treadmill or a pedometer for measuring distance travelled, and the like. Hereinafter, an image representing the measurement device 10 may be referred to as a “captured image.”

The storage unit 130 may store images representing various measurement devices, along with types of the measurement devices. The types of the measurement devices may be information used to identify the measurement devices for each function, for example, blood pressure, blood sugar, body weight, pulse, and the like. The images and the types of the measurement devices may be stored as defaults, e.g., when the portable apparatus 100 is marketed.

Additionally, the storage unit 130 may store at least one of the captured images acquired by the image capturing unit 120, and the measurement data extracted by the controller 140. For example, in response to an image corresponding to the captured image representing the measurement device 10 not being stored in the storage unit 130, or in response to an image representing the type of the measurement device 10 not being stored in the storage unit 130, the storage unit 130 may store the captured image together with a type of the measurement data. Also, the storage unit 130 may store the measurement data along with metadata that will be described below.

Examples of items stored in the storage unit 130 for each of the images representing the measurement devices are shown in Table 1.

TABLE 1

| Items | Image 1 | Image 2 |
|---|---|---|
| Type of measurement data | Blood sugar | Blood pressure |
| (Type of measurement device) | | |
| Measurement unit | mg/dl | mmHg |
| Measurement time | 10:00 a.m. | 10:10 a.m. |
| Measurement location | Home | Home |
| User | User 1 | User 2 |

The items of Table 1 are merely examples; accordingly, other items may be added or omitted.

The controller 140 may control an overall operation of the portable apparatus 100, based on a user's request that is input through the UI unit 110. In response to the captured image representing the measurement device 10 being received from the image capturing unit 120, the controller 140 may determine the type of the measurement data, and may extract the measurement data from the captured image.

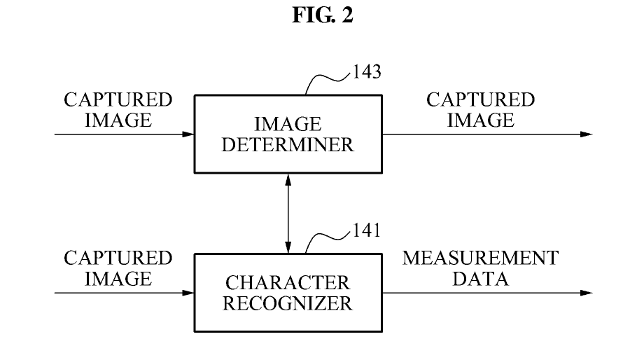

Accordingly, the controller 140 may include a character recognizer 141, and an image determiner 143, as shown in FIG. 2. The character recognizer 141 and the image determiner 143 may be implemented as a single control module, or separately as a character recognition module and an image determination module, respectively.

The character recognizer 141 may extract the measurement data from the captured image. In other words, the character recognizer 141 may extract the measurement data measured by the measurement device 10. In response to the measurement data being represented by numerals, the character recognizer 141 may extract the measurement data using a well-known character recognition scheme. In response to the measurement data being represented by numerals and unit symbols, the character recognizer 141 may extract the measurement data using the well-known character recognition scheme. For example, examples of unit symbols may include kilogram (kg), kilometers/hour (km/h), milligrams/deciliter (mg/dl), and the like. Additionally, in response to the measurement data being represented in an analog form, the character recognizer 141 may extract the measurement data using a known pattern recognition scheme.

The image determiner 143 may determine whether an image corresponding to the captured image exists in the storage unit 130 among a plurality of images that represent a plurality of measurement devices and that are stored in advance in the storage unit 130. For example, the image determiner 143 may compare and analyze similarity between the captured image and each of the plurality of images, and may determine whether the image corresponding to the captured image exists in the storage unit 130.

In response to the image corresponding to the captured image existing in the storage unit 130, the image determiner 143 may determine the type of the measurement data. The type of the measurement data may be determined based on the image corresponding to the captured image. For example, the image determiner 143 may determine a type of the image corresponding to the captured image to be the type of the measurement data. As another example, the image determiner 143 may analyze a pattern of the captured image, may compare the analyzed pattern with patterns of the images stored in advance, and may determine the type of the measurement data. The measurement data may be generated by the measurement device 10, and the type of the measurement data may be determined based on the type of the measurement device 10.

In response to the type of the measurement data being determined based on the image determiner 143, the controller 140 may control the storage unit 130 to store the measurement data extracted by the character recognizer 141, together with the determined type of the measurement data. Additionally, the controller 140 may form metadata based on at least one of the type of the measurement data, a time at which the measurement data is measured, a location where the measurement data is measured, and information regarding a user corresponding to the measurement data. The controller 140 may control the storage unit 130 to store the formed metadata, along with the measurement data. Information on the location may be provided when the portable apparatus 100 includes a location measurement device, such as a Global Positioning System (GPS) module.

In response to the image corresponding to the captured image not existing in the storage unit 130, the controller 140 may control the UI unit 110 to display a UI that receives an input of the type of the measurement data. The UI unit 110 may display a list that shows the type of the measurement data all at once, and may enable a user to select a desired type of the measurement data from the displayed list. Alternatively, the UI unit 110 may generate a UI that enables a user to manually input the type of the measurement data, and may display the generated UI.

In response to a type of measurement data being input through the UI unit 110, the controller 140 may control the storage unit 130 to store the captured image together with the received type of measurement data. The stored captured image may be used to determine a type of measurement data when the measurement device 10 is re-captured later.

Additionally, the controller 140 may control the storage unit 130 to store the measurement data extracted by the character recognizer 141, together with the received type of measurement data. The controller 140 may form the metadata as described above, and may control the storage unit 130 to store the metadata together with the extracted measurement data.

The communication unit 150 may transmit the measurement data extracted by the character recognizer 141 to a management server 200. An address for the management server 200 may be set for each of the images that represent the measurement devices and that are stored in the storage unit 130. The communication unit 150 may transmit the measurement data to the management server 200 each time the measurement data is extracted, or each time the portable apparatus 100 accesses a network.

The management server 200 may be used to collect the measurement data and to manage a user's status. The management server 200 may be configured for each manufacturer of the measurement device 10, or for each user. In an example in which the management server 200 is configured for each user, the management server 200 may be a Personal Computer (PC).

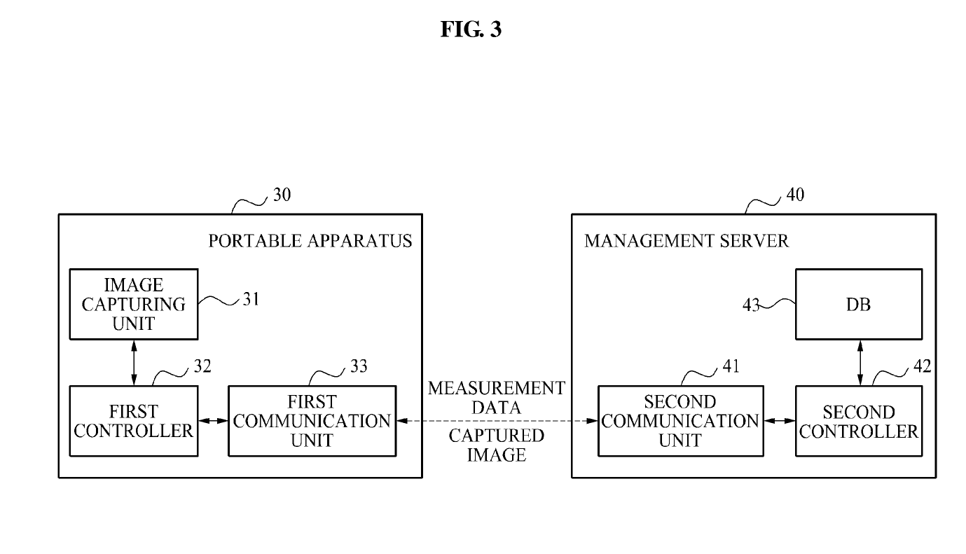

FIG. 3 is a block diagram illustrating an example of a system for processing measurement data according to an embodiment.

Referring to FIG. 3, the system may include a portable apparatus 30 and a management server 40.

The portable apparatus 30 may include an image capturing unit 31, a first controller 32, and a first communication unit 33. The image capturing unit 31 may be used as a camera module, and may acquire a captured image by capturing a measurement device on which measurement data is displayed. For example, the measurement device 10 described with reference to FIG. 1 may be captured by the image capturing unit 31.

The first controller 32 may extract the measurement data from the captured image using a character recognition scheme or a pattern recognition scheme. The first controller 32 may form metadata regarding the extracted measurement data.

The first communication unit 33 may transmit, to the management server 40, at least one of the extracted measurement data, the captured image, and the metadata.

The management server 40 may store at least one of the received measurement data, the received captured image, and the received metadata, and may manage the user's status. The management server 40 may be configured for each manufacturer of the measurement device, or for each user. In an example in which the management server 40 is configured for each user, the management server 40 may be a PC. As shown in FIG. 3, the management server 40 may include a second communication unit 41, a second controller 42, and a database DB 43.

The second communication unit 41 may receive, from the portable apparatus 30, at least one of the measurement data, the captured image, and the metadata, and may provide the second controller 42 with the at least one received data. The second controller 42 may control the DB 43 to store at least one of the received measurement data, the received captured image, and the received metadata. In response to user identification information being contained in the metadata, the second controller 42 may control the DB 43 to store at least one of the measurement data, the captured image, and the metadata for each user. In response to a user's requesting a report about his or her measurement data later, the second controller 42 may generate a report based on the measurement data, the captured image, and the metadata that are stored in the DB 43, and may provide the user with the report.

As another example, the portable apparatus 30 may transmit the acquired captured image to the management server 40, not extract the measurement data. In one example, the management server 40 may extract the measurement data from the received captured image, and may store the extracted measurement data.

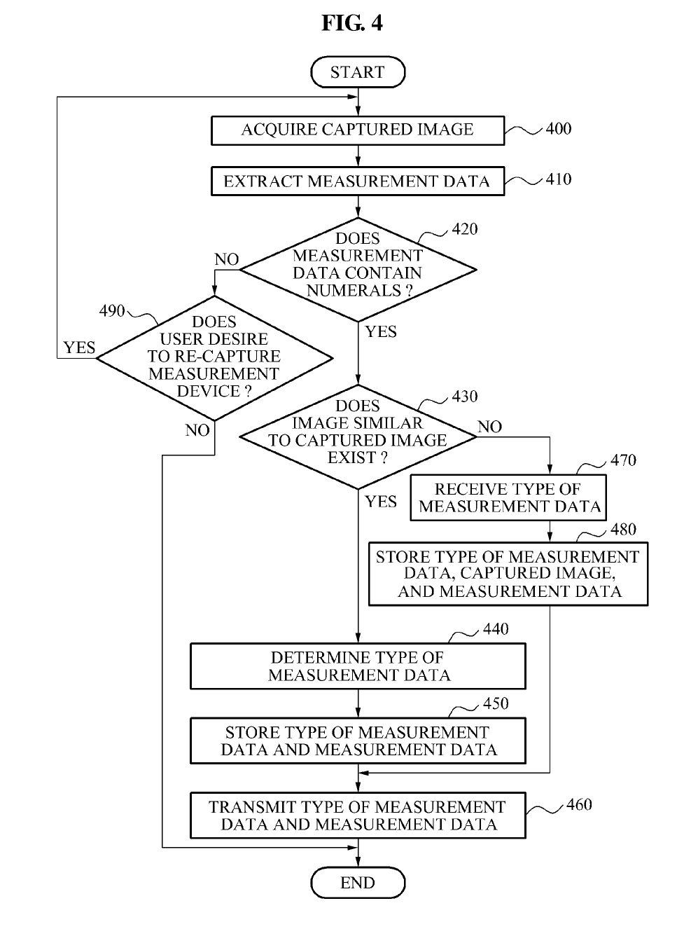

FIG. 4 is a flowchart illustrating an example of a method of processing measurement data by a portable apparatus according to an embodiment.

The method of FIG. 4 may be performed by the portable apparatus 100 of FIG. 1.

In operation 400, the portable apparatus may acquire a captured image by capturing a measurement device on which measurement data is displayed.

In operation 410, the portable apparatus may analyze the captured image, may recognize that the captured image contains characters, and may extract the characters, e.g., the measurement data, from the captured image.

In response to the extracted measurement data containing numerals in operation 420, the portable apparatus may determine whether an image stored in advance in the portable apparatus is similar to the captured image, in operation 430.

In response to the image stored in advance being similar to the captured image in operation 430, the portable apparatus may determine a type of the measurement data in operation 440. The type of the measurement data may be determined based on an image corresponding to the captured image among a plurality of images that represent a plurality of measurement devices and that are stored in advance.

In operation 450, the portable apparatus may store the determined type of the measurement data, and the extracted measurement data. For example, the portable apparatus may form metadata as described above, and may further store the metadata.

In operation 460, the portable apparatus may transmit, to a management server, the stored type of the measurement data and the stored measurement data.

Conversely, in response to an image stored in advance not being similar to the captured image in operation 430, the portable apparatus may receive a type of the measurement data that is input by a user through a UI in operation 470.

In operation 480, the portable apparatus may store the received type of the measurement data, the acquired captured image, and the extracted measurement data. For example, the portable apparatus may form metadata as described above, and may further store the metadata.

In response to the extracted measurement data not containing numerals in operation 420, the portable apparatus may ask the user whether he or she desires to re-capture the measurement device in operation 490.

When the user desires to re-capture the measurement device, the portable apparatus may return to operation 400.

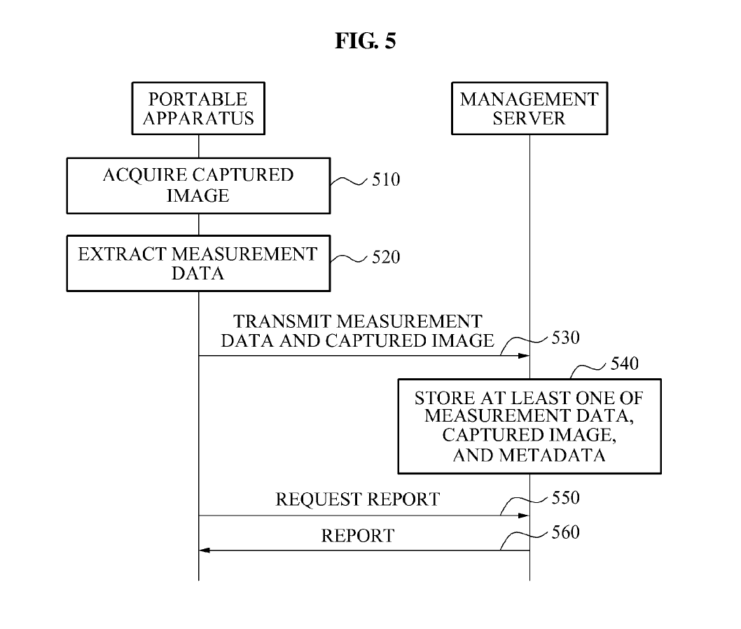

FIG. 5 is a flowchart illustrating an example of a method of processing measurement data by a portable apparatus and a management server according to an embodiment.

The portable apparatus and the management server of FIG. 5 may be respectively implemented as the portable apparatus 30 and the management server 40 that are described above with reference to FIG. 3.

In operation 510, the portable apparatus may acquire a captured image by capturing a measurement device on which measurement data is displayed.

In operation 520, the portable apparatus may extract the measurement data from the captured image.

In operation 530, the portable apparatus may transmit the extracted measurement data and the captured image to the management server. For example, the portable apparatus may form metadata as described above, and may further store the metadata.

In operation 540, the management server may store at least one of the received measurement data, the received captured image, and the metadata, and may manage a user's status.

In response to a user's requesting a report about his or her measurement data using the portable apparatus or other apparatuses in operation 550, the management server may make a report based on the measurement data, the captured image, and the metadata that are stored in a DB of the management server, and may provide the user with the report in operation 560.

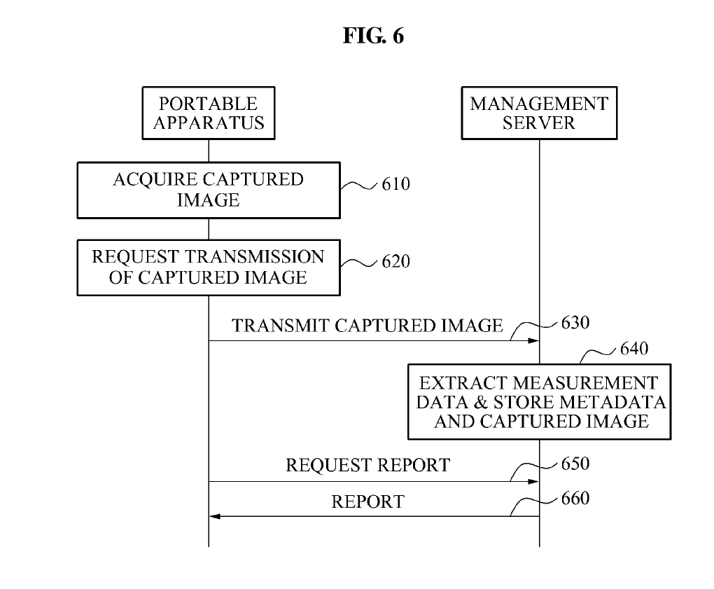

FIG. 6 is a flowchart illustrating another example of a method of processing measurement data by a portable apparatus and a management server according to an embodiment.

The portable apparatus and the management server of FIG. 6 may be respectively implemented as the portable apparatus 30 and the management server 40 that are described above with reference to FIG. 3.

In operation 610, the portable apparatus may acquire a captured image by capturing a measurement device on which measurement data is displayed.

In response to a user's requesting a transmission of the captured image using the portable apparatus in operation 620, the portable apparatus may transmit the captured image to the management server in operation 630. Alternatively, in response to a set or predetermined transmission time elapsing, the portable apparatus may transmit the captured image to the management server in operation 630. For example, the portable apparatus may form metadata as described above, and may further store the metadata.

In operation 640, the management server may extract the measurement data from the received captured image, and may store the metadata and the captured image in a DB of the management server.

In response to the user's requesting a report about his or her measurement data in operation 650, the management server may generate a report based on the measurement data, the captured image, and the metadata that are stored in the DB, and may provide the user with the report in operation 660.

According to embodiments, it is possible to automatically extract and collect measurement data by only capturing (photographing) a measurement device. Thus, a user may manage frequently generated measurement data by only a single capturing operation, without performing a complex operation.

Additionally, according to embodiments, a user may capture a measurement device along with measurement data displayed on the measurement device, using a portable apparatus. The portable apparatus may store a variety of information, such as an image representing the capture measurement device, a type of the capture measurement device, and the measurement data, and may provide a management server with the stored information. Thus, it is possible to update and manage the measurement data and other information associated with the user.

Furthermore, according to embodiments, in response to a measurement device being implemented as a device enabling a display of a quantity of motion, for example, a treadmill, an exercise bicycle, or a pedometer, a user may capture the measurement device, to manage his or her quantity of motion.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the devices described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup and/or set top box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A portable apparatus, comprising:
an image capturing unit configured to acquire a captured image by capturing a measurement device on which measurement data is displayed;
a controller configured to extract the measurement data from the acquired captured image; and
a storage unit configured to store at least one of: the extracted measurement data and the acquired captured image.

2. The portable apparatus of claim 1, wherein the controller is further configured to:
extract the measurement data from the acquired captured image; and
control the storage unit to store the extracted measurement data, in response to an image corresponding to the measurement device existing among a plurality of images that represent a plurality of measurement devices and that are stored in advance.

3. The portable apparatus of claim 1, further comprising a User Interface (UI) unit configured to receive a type of the measurement data, the type being input by a user.

4. The portable apparatus of claim 3, wherein the controller is further configured to control the storage unit to store the measurement data and the type of the measurement data received by the UI unit, in response to an image corresponding to the measurement device not existing among a plurality of images that represent a plurality of measurement devices and that are stored in advance.

5. The portable apparatus of claim 1, further comprising a communication unit configured to transmit the extracted measurement data to a management server.

6. The portable apparatus of claim 1, wherein the controller is further configured to control the storage unit to further store at least one of: a type of the measurement data, a time at which the measurement data is measured, a location where the measurement data is measured, and information regarding a user corresponding to the measurement data.

7. The portable apparatus of claim 6, wherein the type of the measurement data is determined based on an image corresponding to the measurement device among a plurality of images that represent a plurality of measurement devices and that are stored in advance.

8. The portable apparatus of claim 6, wherein, in response to the acquired captured image comprising a unit symbol for the measurement data, the controller is further configured to:
extract the unit symbol along with the measurement data; and
control the storage unit to store the extracted unit symbol and the extracted measurement data.

9. A method of processing measurement data in a portable apparatus, the method comprising:
acquiring a captured image by capturing a measurement device on which measurement data is displayed;
extracting the measurement data from the acquired captured image; and
storing at least one of the extracted measurement data and the acquired captured image.

10. The method of claim 9, wherein the extracting comprises extracting the measurement data from the acquired captured image, in response to an image corresponding to the measurement device existing among a plurality of images that represent a plurality of measurement devices and that are stored in advance.

11. The method of claim 9, further comprising:
receiving a type of the measurement data, in response to an image corresponding to the measurement device not existing among a plurality of images that represent a plurality of measurement devices and that are stored in advance, the type being input by a user; and
storing the received type of the measurement data.

12. The method of claim 9, further comprising transmitting the extracted measurement data to a management server.

13. The method of claim 9, wherein the storing comprises further storing at least one of: a type of the measurement data, a time at which the measurement data is measured, a location where the measurement data is measured, and information regarding a user corresponding to the measurement data.

14. The method of claim 13, wherein the type of the measurement data is determined based on an image corresponding to the measurement device among a plurality of images that represent a plurality of measurement devices and are stored in advance.

15. A non-transitory computer readable recording medium storing a program to cause a computer to implement the method of claim 9.

16. A portable apparatus, comprising:
an image capturing unit configured to acquire a captured image by capturing a measurement device on which measurement data is displayed;
a controller configured to extract the measurement data from the acquired captured image; and
a communication unit configured to transmit, to a management server, at least one of: the extracted measurement data and the acquired captured image.

17. The portable apparatus of claim 16, wherein the controller is further configured to:
extract the measurement data from the acquired captured image; and
control the storage unit to store the extracted measurement data, in response to an image corresponding to the measurement device existing among a plurality of images that represent a plurality of measurement devices and that are stored in advance.

18. The portable apparatus of claim 16, further comprising a User Interface (UI) unit configured to receive a type of the measurement data, the type being input by a user.

19. The portable apparatus of claim 18, wherein the controller is further configured to control the storage unit to store the measurement data and the type of the measurement data received by the UI unit, in response to an image corresponding to the measurement device not existing among a plurality of images that represent a plurality of measurement devices and that are stored in advance.

20. The portable apparatus of claim 16, wherein the controller is further configured to control the storage unit to further store at least one of: a type of the measurement data, a time at which the measurement data is measured, a location where the measurement data is measured, and information regarding a user corresponding to the measurement data.
